(19) United States
(12) Patent Application Publication
(10) Pub. No.: US 2017/0134384 A1
(43) Pub. Date: May 11, 2017

(54) METHOD AND DEVICE FOR OBTAINING SUPERUSER PERMISSION

(71) Applicants: LE HOLDINGS (BEIJING) CO., LTD., BEIJING (CN); LEMOBILE INFORMATION TECHNOLOGY (BEIJING) CO., LTD., BEIJING (CN)

(72) Inventors: Chen Chen, Beijing (CN); Chao He, Beijing (CN)

(21) Appl. No.: 15/245,057

(22) Filed: Aug. 23, 2016

Related U.S. Application Data
(63) Continuation of application No. PCT/CN2016/089104, filed on Jul. 7, 2016.

(30) Foreign Application Priority Data
Nov. 6, 2015 (CN) 201510756758.2

(51) Int. Cl. H04L 29/06

(52) U.S. Cl. CPC H04L 63/10; H04L 63/0876

(57) ABSTRACT

The embodiment of the present disclosure discloses a method and device for obtaining superuser permission. The method for obtaining the superuser permission includes the steps that an attribute value corresponding to the superuser permission is monitored at the initialization phase of a first terminal; an debug bridge service is restarted when the attribute value is valid; a pre-stored first identification code is verified in the restarting process of the debug bridge service, wherein the first identification code is obtained according to the unique identification code of the first terminal; and the superuser permission is reserved when the first identification code passes the verification. By the adoption of the method and device for obtaining the superuser permission, the process of obtaining the superuser permission may be achieved without a PC, and thus the superuser permission may be obtained conveniently and flexibly on any occasions.

### CROSS-REFERENCE TO RELATED APPLICATIONS

This application is a continuation of International Application No. PCT/CN2016/089104, filed on Jul. 7, 2016, which is based upon and claims priority to Chinese Patent Application No. 201510756758.2, entitled “METHOD AND DEVICE FOR OBTAINING SUPERUSER PERMISSION”, filed to State Intellectual Property Office of The P.R.C. on Nov. 6, 2015, the entire contents of which are incorporated herein by reference.

### TECHNICAL FIELD

The embodiment of present disclosure generally relates to the technical field of mobile terminals, in particular to a method and device for obtaining superuser permission.

### BACKGROUND

With the continuous development of the mobile terminal technique, more attention is paid to the safety of mobile terminals gradually under the condition that the function of the mobile terminals becomes more and more powerful.

At present, Android system generally has superuser (root) permission and common user permission, wherein root is the unique superuser in the system and has all permission, such as the permission of starting or stopping a process, the permission of deleting or adding a user and the permission of adding or disable hardware, in the system. Since the root permission is so powerful, extremely severe potential safety hazards may exist if the root permission is started by default, and for this reason, the root permission of the mobile terminals such as mobile phones and tablet computers is stopped by default when the mobile terminals leave the factory. In this way, users generally only have the common user permission when using the mobile terminals.

In practical application, the users need to obtain the root permission sometimes to execute certain operation, for example, the users need to install or delete a certain application program in the mobile phones. At present, the root permission of the mobile phones is obtained generally through the following method that the mobile phones are connected with a PC (Personal Computer) through a universal serial bus (USB), and the root permission of the mobile phones is obtained through ADB (Android Debug Bridge) command operation.

However, in the process of obtaining the root permission of the mobile phones, a PC is required; the root permission may not be obtained on the occasion that no PC is available, and the ADB command operation is needed for obtaining the root permission, and consequentially the process of obtaining the root permission is quite complex and inflexible.

### SUMMARY

An embodiment of the present disclosure discloses a method and device for obtaining superuser permission. The method and device for obtaining the superuser permission are used for overcoming the defect that in the prior art, the process of obtaining the root permission is quite complex and inflexible. A method for obtaining root permission easily and conveniently is provided, and the root permission obtaining process is more flexible.

According to one aspect of the present disclosure, an embodiment of the present disclosure provides a method for obtaining the superuser permission, and the method for obtaining the superuser permission includes the steps that:

an attribute value corresponding to the superuser permission is monitored at the initialization phase of a first terminal;

a debug bridge service is restarted when the attribute value is valid;

a prestored first identification code is verified in the restarting process of the debug bridge service; wherein the first identification code is obtained according to the unique identification code of the first terminal;
the superuser permission is reserved when the first identification code passes the verification.

According to another aspect of the present disclosure, an embodiment of the present disclosure provides a mobile terminal for obtaining superuser permission, which includes at least one processor; and a memory communicably connected with the at least one processor for storing instructions executable by the at least one processor, wherein execution of the instructions by the at least one processor causes the at least one processor to:

monitor an attribute value corresponding to the superuser permission at the initialization phase of a first terminal;

restart a debug bridge service when the attribute value is valid;

verify the pre-stored first identification code in the restarting process of the debug bridge service; wherein the first identification code is obtained according to the unique identification code of the first terminal;

reserve the superuser permission when the first identification code passes the verification.

According to another aspect of the present disclosure, a computer program is provided. The computer program includes a computer readable code. A mobile terminal executes the method for obtaining the superuser permission when the computer readable code operates on the mobile terminal.

According to another aspect of the present disclosure, a computer readable medium is provided, wherein the computer program is stored in the computer readable medium.

The present disclosure has the beneficial effects that:

according to the present disclosure, at the initialization phase of the first terminal, the debug bridge service is restarted if it is monitored that the attribute value corresponding to the superuser permission is valid, and since the debug bridge service is restarted at the initialization phase, the restarted debug bridge has the superuser permission; the pre-stored first identification code is further verified at the moment, and the superuser permission may be reserved when the identification code passes the verification. By the adoption of the method and device, the process of obtaining the superuser permission may be achieved without the PC, and thus the superuser permission may be obtained conveniently and flexibly on any occasions.

The foregoing description is only the summary of the present disclosure, for a clearer understanding of the technological means of the present disclosure, implementation may be conducted according to the specification, and for a better understanding of the foregoing description and other purposes, characteristics and advantages of the present disclosure, the detailed description of embodiments of the present disclosure is given as examples.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a step flow diagram according to a first embodiment of the present disclosure of the method for obtaining the superuser permission.

FIG. 2 shows a step flow diagram according to a second embodiment of the present disclosure of the method for obtaining the superuser permission.

FIG. 3 shows a flow diagram according to an application example of the present disclosure of obtaining the superuser permission.

FIG. 4 shows a structure diagram according to an embodiment of the present disclosure of the device for obtaining the superuser permission.

FIG. 5 schematically shows a block diagram according to a mobile terminal for executing the method of the present disclosure.

FIG. 6 schematically shows a storage unit used for maintaining or carrying a program code for achieving the method of the present disclosure.

### DETAILED DESCRIPTION

For a cleaner understanding of the purposes, technical schemes and advantages of the embodiments of the present disclosure, the technical schemes of the embodiments of the present disclosure are described clearly and completely with the accompanying drawings in the embodiments of the present disclosure; apparently, the described embodiments are only part of the present disclosure, and not all of the present disclosure. Based on the embodiments in the present disclosure, all other embodiments obtained by those skilled in the field without any creative work are within the scope of the present disclosure.

### A FIRST EMBODIMENT

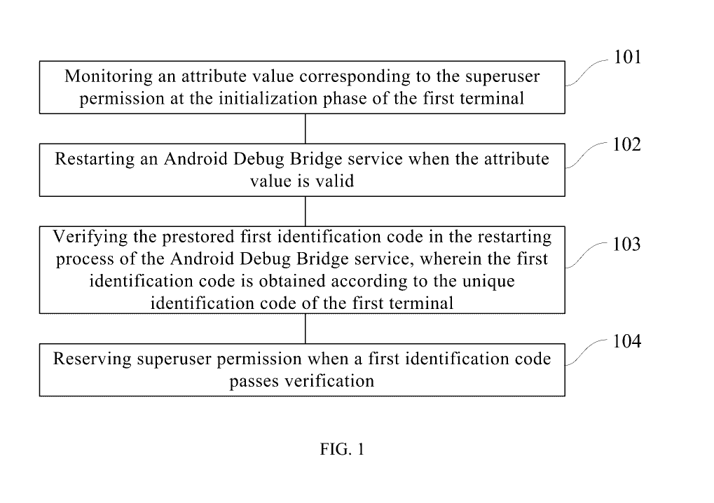

According to the FIG. 1 showing the step flow diagram according to the first embodiment of the method for obtaining the superuser permission, the method specifically may include the steps of:

step 101, monitoring an attribute value corresponding to the superuser permission at the initialization phase of a first terminal;

step 102, restarting a debug bridge service when the attribute value is valid.

The embodiment of the present disclosure may be used for obtaining the root permission of mobile terminals, wherein the mobile terminals may include cell phones, smart phones, laptop computers, PCs, e-book terminals, digital broadcasting terminal, PDAs (Personal Digital Assistant), portable multimedia players, navigation systems and the like. It may be understood that the specific forms of the mobile terminals are not limited by the embodiment. For the convenience of description, a mobile phone is taken as an example in the embodiment of the present disclosure, and other application occasions may take the mobile phone as the reference.

In the embodiment of the present disclosure, before the root permission of a first terminal is obtained, two attribute values in a system may be modified as follows: a first identification code of the first terminal is prestored firstly, specifically the first identification code may be stored in the debug.service.info attribute value of the first terminal, the first identification code is a verification code for obtaining the root permission in the embodiment of the present disclosure, and obtaining of the root permission fails if the first identification code stored in the debug.service.info attribute value is not a first identification code corresponding to the terminal; secondly, the attribute value, corresponding to the superuser permission, in the first terminal is set to be valid, specifically, the attribute value of service.adb.root may be set to be 1, and in the embodiment of the present disclosure, when the attribute value of the service.adb.root is monitored to be 1 at the initialization phase, the may restarted, so that the root permission is obtained.

In a preferred embodiment of the present disclosure, the first identification code may be prestored through the steps as follows.

Step S11, the unique identification code of the first terminal is sent to a second terminal through wireless connection so that the second terminal may determine the first identification code corresponding to the first terminal according to the unique identification code of the first terminal;

wherein the unique identification code specifically may be the IMEI (International Mobile Equipment Identity), and the IMEI is commonly known as the mobile phone identification number and is the unique identification code of the mobile phone. In practical application, a client is generally not allowed to have the root permission of the mobile phone and only may have the root permission at the debugging phase of the mobile phone, and thus for the safety of the mobile phone, the mobile phone is not allowed to obtain the first identification code. According to the embodiment of the present disclosure, the first identification code of the first terminal is obtained through another mobile phone (the second terminal), and the second terminal may be a terminal having special permission functions. Of course, it is available that the first identification code is determined through the first terminal under the low safety requirement condition. The specific way in which the first identification code is obtained is not limited by the present disclosure.

In one preferred embodiment of the present disclosure, the wireless connection may be infrared connection. Specifically, the first terminal may send the unique identification code of the first terminal to the second terminal through infrared connection, the second terminal receives the unique identification code of the first terminal through infrared connection and works out the first identification code corresponding to the first terminal through a preset algorithm, and the second terminal sends the first identification code to the first terminal through infrared connection. Wireless data transmission between mobile phones and between mobile phones and computers may be achieved through infrared connection, and since data transmission only may be achieved under the connection condition, infrared connection is high in safety and has the advantages that the speed is high, and the flow cost is avoided. It may be understood that in practical application, those skilled in the field may select the proper wireless connection way, such as a Bluetooth connection way and a wireless network Wi-Fi connection way, according to requirements. The specific way of wireless connection is not limited by the embodiment of the present disclosure.

Step S12, the first identification code from the second terminal is received and stored through wireless connection.

Specifically, the first terminal receives the first identification code, corresponding to the first terminal, worked out by the second terminal through infrared connection and stores the first identification code in the debug,service.info attribute value.

After the two attribute values are modified, the attribute value, namely the attribute value of service,adb.root, corresponding to the superuser permission may be monitored at the initialization phase of the first terminal; when the attribute value of the service,adb.root is 1, the adbd service is restarted, and the adbd service is a system service configured in init.rc and is started through an init process; since the adbd service is started at the initialization phase, the restarted adbd service has the root permission.

Step 103, verifying the prestored first identification code in the restarting process of the debug bridge service; wherein the first identification code is obtained according to the unique identification code of the first terminal.

Under normal conditions, at the initialization phase, the adbd service may execute a setgid(AID_SHELL) function and a setuid(AID_SHELL) function after being started so as to switch the root permission into the shell permission, so that the situation that a user may obtain the root permission after initialization is completed is avoided. According to the present disclosure, the root permission may still be reserved after initialization is completed, namely execution of the setgid function and the setuid function is made failed so as to prevent the root permission from being switched into the shell permission, and thus the root permission may still be obtained. In the embodiment of the present disclosure, the prestored first identification code is verified, and the adbd service does not execute the setgid function and the setuid function any more when the first identification code passes the verification so that the root permission may be prevented from being switched into the shell permission, and accordingly the root permission may be reserved.

In a preferred embodiment of the present disclosure, the prestored first identification code may be verified specifically through the steps as follows.

Step S21, a second identification code is determined according to the unique identification code of the first terminal.

In the embodiment of the present disclosure, when the prestored first identification code is verified, the second identification code is determined firstly according to the unique identification code of the first terminal through a preset algorithm, wherein the preset algorithm used for determining the second identification code is the same as the preset algorithm used for determining the first identification code. In this way, the first identification code and the second identification code which are determined according to the unique identification code of the first terminal through the same preset algorithm should be the same; if the first identification code and the second identification code are the same, the first identification code passes the verification; otherwise, it is indicated that the prestored first identification code is not a correct identification code corresponding to the first terminal, namely an incorrect first identification code is stored or the stored first identification code is distorted, and the verification fails.

Step S22, the second identification code is matched with the prestored first identification code, and it is determined that the first identification code passes the verification when the matching succeeds.

Step 104, reserving the superuser permission when the first identification code passes the verification.

In practical application, if the first identification code passes the verification, the adbd service does not execute the setgid function or the setuid function any more so that the root permission may be prevented from being switched into the shell permission, and accordingly the root permission is reserved.

In conclusion, when it is monitored at the initialization phase of the first terminal that the attribute value corresponding to the superuser permission is valid, the debug bridge service is restarted, and since the debug bridge is restarted at the initialization phase, the restarted debug bridge service has the superuser permission; the prestored first identification code is further verified at the moment, and the superuser permission may be reserved when the first identification code passes the verification. Through the embodiment of the present disclosure, the process of obtaining the superuser permission may be achieved without the PC, and thus the superuser permission may be obtained conveniently and flexibly on any occasions.

### A SECOND EMBODIMENT

A second embodiment may further include the following optional technical schemes on the basis of the first embodiment. According to the second embodiment, wireless connection between a first terminal and a second terminal is established, the root permission of the first terminal is obtained by means of the second terminal, the root permission may be obtained under the condition that the first terminal does not need to be connected with a PC, and thus the root permission may be obtained more flexibly.

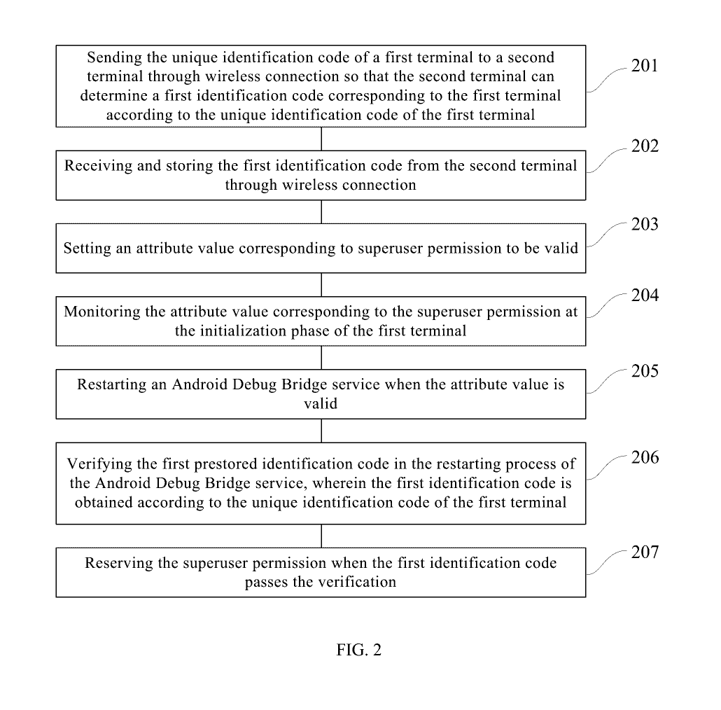

According to the FIG. 2 showing the step flow diagram according to the second embodiment of the present disclosure of the method for obtaining the superuser permission, the method specifically may include the steps as follows.

Step 201, sending the unique identification code of the first terminal to the second terminal through wireless connection so that the second terminal may determine a first identification code corresponding to the first terminal according to the unique identification code of the first terminal.

In practical application, the first terminal may send the unique IMEI of the first terminal to the second terminal through wireless connection, and a daemon process in the second terminal may generate the first identification code corresponding to the first terminal according to the unique IMEI number of the first terminal through a preset algorithm.

Step 202, receiving and storing the first identification code from the second terminal through wireless connection.

Specifically, the first terminal may receive the first identification code from the second terminal through wireless connection and stores the first identification in a debug.service.info attribute value.

Step 203, setting the attribute value corresponding to the superuser permission to be valid.

Specifically, the attribute value of service.adb.root may be set to be 1 after the first terminal stores the first identification code in the debug.service.info attribute value.

Step 204, monitoring the attribute value corresponding to the superuser permission at the initialization phase of the first terminal.

Specifically, the attribute value of the service.adb.root is monitored at the initialization phase of the first terminal, and the debug bridge service is restarted when the attribute value is valid, namely the attribute value is 1.

Step 205, restarting the debug bridge service when the attribute value is valid.

Step 206, verifying the first identification code in the restarting process of the debug bridge service; wherein the first identification code is obtained according to the unique identification code of the first terminal.

Specifically, in the restarting process of the adbd service, the first identification code in the debug.service.info attribute value is verified, namely whether the first identification code is consistent with a second identification code or not is determined, and the second identification code is obtained according to the unique IMEI of the first terminal through a preset algorithm the same as the preset algorithm for determining the first identification code; if the first identification code is consistent with the second identification code, the first identification code passes the verification.

Step 207, reserving the superuser permission when the first identification code passes the verification.

In conclusion, in the embodiment of the present disclosure, wireless connection between the first terminal and the second terminal is established, the root permission of the first terminal is obtained by means of the second terminal, the root permission may be obtained under the condition that the first terminal does not need to be connected with a PC, and thus the root permission may be obtained more flexibly; in addition, due to the facts that the first terminal does not need to be connected with the PC through a USB and the root permission is obtained through ADB command operation, the process of obtaining the root permission is made easier and more convenient.

### FIRST APPLICATION EXAMPLE

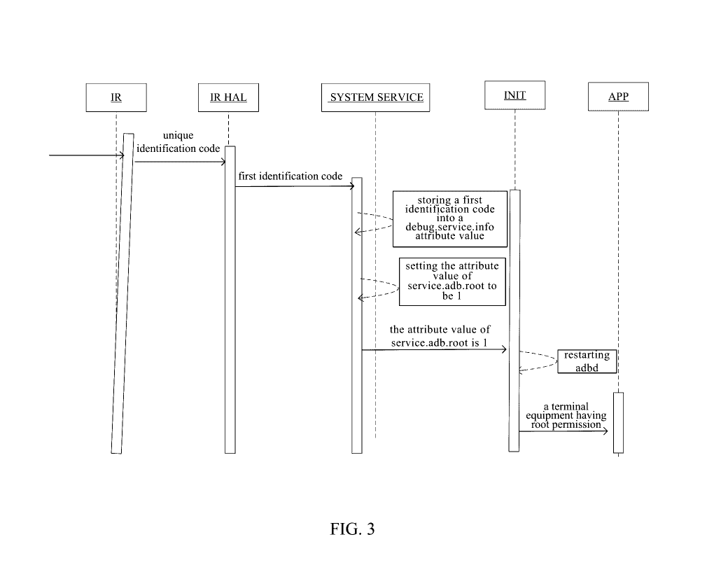

For a cleaner description of the method for obtaining the superuser permission, the following specific application example is used for explanation. According to the application example, the root permission of a mobile phone A is obtained through a mobile phone B, and infrared connection is established between the mobile phone A and the mobile phone B. According to the FIG. 3 showing the step schematic diagram of the application example for obtaining the superuser permission, the process for obtaining the root permission of the mobile phone A includes the specific steps as follows.

Step S31, the mobile phone A sends the unique IMEI number of the mobile phone A to the second mobile phone B through IR (Infrared Radiation).

Step S32, the mobile phone B generates a first identification code, namely the magic number, corresponding to the mobile phone A according to the unique IMEI number of the mobile phone A through a preset algorithm.

Specifically, after the mobile phone B receives the unique IMEI number from the mobile phone A through IR, a daemon process in the mobile phone B may generate the magic number corresponding to the mobile phone A according to the unique IMEI number of the mobile phone A through the preset algorithm.

Step S33, the mobile phone B sends the magic number to the mobile phone A through IR.

Step S34, the mobile phone A receives and stores the magic number through IR.

Specifically, the mobile phone A stores the received magic number into a debug.service.info attribute value through a daemon process of the mobile phone A.

Step S35, the attribute value of service.adb.root in the mobile phone A is set to be 1.

In specific application, after the attribute value of the service.adb.root in the mobile phone A is set to be 1, an adbd process may be restarted after an initialization process monitors that the attribute value of the service.adb.root is 1, and whether the debug.service.info attribute value (the first identification code) stored by the mobile phone A is the same as a second identification code worked out by the mobile phone A through the same algorithm or not is determined in the starting process of the adbd process; if the debug.service.info attribute value (the first identification code) is the same as the second identification code, the mobile phone A does not execute setgid operation or setuid operation, and thus the root permission of the mobile phone A is reserved; if the debug.service.info attribute value (the first identification code) is different from the second identification code, the mobile phone A executes the setgid operation and the setuid operation, and the mobile phone A loses the root permission.

Step S36, the attribute value of the service.adb.root is monitored at the initialization phase of the mobile phone A, and an adbd service is restarted through the root permission when the attribute value is 1.

Step S37, the first identification code in the debug.service.info attribute value is verified in the starting process of the adbd service.

Step S38, the superuser permission is reserved when the first identification code passes the verification.

### SECOND APPLICATION EXAMPLE

According to the application example, a mobile phone A obtains the root permission of the mobile phone A and determines a first identification code of the mobile phone A, and the process for obtaining the root permission of the mobile phone A includes the specific steps as follows.

Step S41, the mobile phone A generates the first identification code, namely the magic number, corresponding to the mobile phone A according to the unique IMEI number of the mobile phone A through a preset algorithm.

Step S42, the mobile phone A stores the magic number into a debug.service.info attribute value.

Step S43, the mobile phone A sets the attribute value of service.adb.root to be 1.

Step S44, the attribute value of the service.adb.root is monitored at the initialization phase of the mobile phone A, and an adbd service is restarted when the attribute value is 1.

Step S45, the first identification code in the debug.service.info attribute value is verified in the restarting process of the adbd service.

Step S46, the superuser permission is reserved when the first identification code passes the verification.

Embodiment of Device

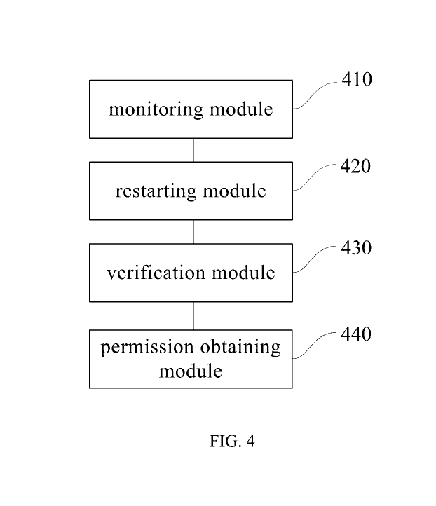

According to the FIG. 4 showing the structure diagram of the device for obtaining the superuser permission, the device specifically may include:

a monitoring module 410, used for monitoring an attribute value corresponding to the superuser permission at the initialization phase of a first terminal;

a restarting module 420, used for restarting a debug bridge service when the attribute value is valid;

a verification module 430, used for verifying a prestored first identification code in the restarting process of the debug bridge service, wherein the first identification code is obtained according to the unique identification code of the first terminal;

a permission obtaining module 440, used for reserving the superuser permission when the first identification code passes the verification.

In one preferred embodiment of the present disclosure, the verification module 430 specifically may include:

a determination submodule, used for determining a second identification code according to the unique identification code of the first terminal;

a matching submodule, used for matching the second identification code with the prestored first identification code and determining that the first identification code passes the verification when the matching succeeds.

In another preferred embodiment of the present disclosure, the first identification code is prestored in a debug.service.info attribute value.

In another preferred embodiment of the present disclosure, the device may further include a storage module, used for prestoring the first identification code;

The storage module specifically may include:

a sending submodule, used for sending the unique identification code of the first terminal to a second terminal so that the second terminal may determine the first identification code corresponding to the first terminal according to the unique identification code of the first terminal;

a receiving submodule, used for receiving and storing the first identification code from the second terminal through wireless connection.

In another preferred embodiment of the present disclosure, the device may further include:

a setting module, used for setting the attribute value corresponding to the superuser permission to be valid after the first identification code is prestored.

In another preferred embodiment of the present disclosure, the wireless connection may be infrared connection.

The forgoing description of the embodiments of the device is provided for illustration only, the units which are described as separated components may be or may not be physically separated, and the components displayed as units may be or may not be physical units, namely the components may be located in the same place or may be distributed on a plurality of network units. The purposes of the embodiments may be achieved by selecting part or all modules according to actual requirements. It may be understood and implemented by those skilled in the field without any creative work.

Each of devices according to the embodiments of the disclosure may be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the interne websites, or be provided in carrier, or be provided in other manners.

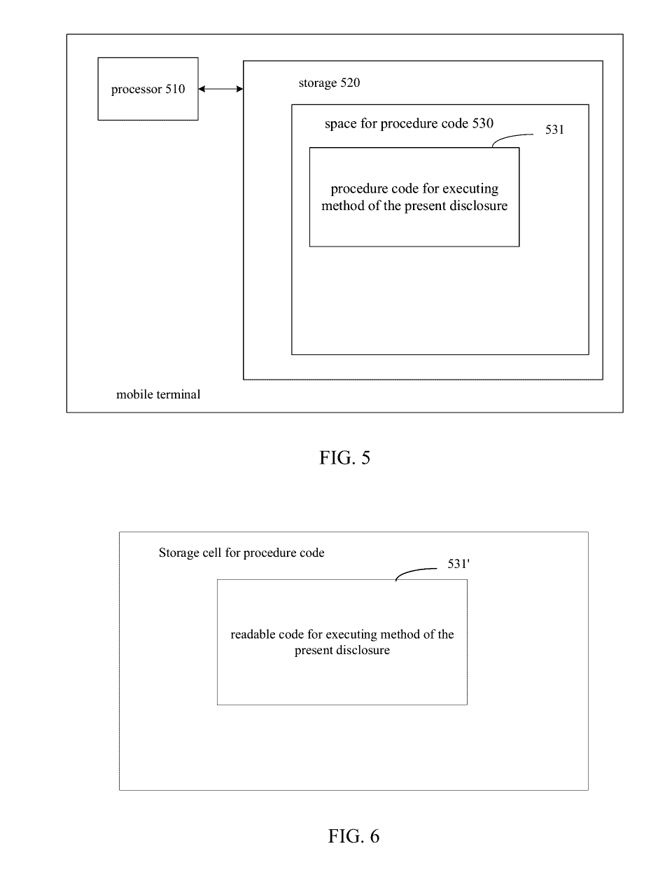

For example, FIG. 5 illustrates a block diagram of a mobile terminal for executing the method according the disclosure. Traditionally, the mobile terminal includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the server as shown in FIG. 5. The program codes may be compressed for example in an appropriate form. Usually, the memory cell includes computer readable codes 531′ which may be read for example by processors 510. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure may be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments may be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings may be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be known that the foregoing embodiments of the present disclosure are provided for illustration only, and are not to limit the present disclosure; although a detailed description of the present disclosure is given by the reference of the foregoing embodiments, it should be understood for those skilled in the field that the technical schemes recorded in the embodiments may still be modified, or equivalent substitution of part of the technical characteristics is still available; although the modification or substitution occurs, corresponding technical schemes do not depart from the spirit and scope of the technical schemes of the embodiments in essence.

What is claimed is:

1. A method for obtaining superuser permission, comprising:
monitoring an attribute value corresponding to the superuser permission at the initialization phase of a first terminal;
restarting a debug bridge service when the attribute value is valid;
verifying a prestored first identification code in the restarting process of the debug bridge service; wherein the first identification code is obtained according to the unique identification code of the first terminal;
reserving the superuser permission when the first identification code passes the verification.

2. The method according to claim 1, wherein the process for verifying the prestored first identification code comprises:
determining a second identification code according to the unique identification code of the first terminal;
matching the second identification code with the prestored first identification code, and determining that the first identification code passes the verification when the matching succeeds.

3. The method according to the claim 1, wherein the first identification code is prestored through the following steps:
sending the unique identification code of the first terminal to the second terminal through wireless connection so that the second terminal determines the first identification code corresponding to the first terminal according to the unique identification code of the first terminal;
receiving and storing the first identification code from the second terminal through wireless connection.

4. The method according to claim 3, wherein the method further comprises:
setting the attribute value corresponding to the superuser permission to be valid after the first identification code is prestored.

5. The method according to the claim 3, wherein the wireless connection is infrared connection.

6. A mobile terminal for obtaining superuser permission, comprising:
at least one processor; and
a memory communicably connected with the at least one processor for storing instructions executable by the at least one processor, wherein execution of the instructions by the at least one processor causes the at least one processor to:
monitor an attribute value corresponding to the superuser permission at the initialization phase of a first terminal;
restart a debug bridge service when the attribute value is valid;
verify a prestored first identification code in the restarting process of the debug bridge service, wherein the first identification code is obtained according to the unique identification code of the first terminal;
reserve the superuser permission when the first identification code passes the verification.

7. The mobile terminal according to claim 6, wherein verify a prestored first identification code in the restarting process of the debug bridge service comprises:
determine a second identification code according to the unique identification code of the first terminal;
match the prestored first identification code with the second identification code and determining that the first identification code passes the verification when matching succeeds.

8. The mobile terminal according to the claim 6, wherein execution of the instructions by the at least one processor causes the at least one processor to further: prestore the first identification code;
prestore the first identification code comprising:
send the unique identification code of the first terminal to the second terminal so that the second terminal determines the first identification code corresponding to the first terminal according to the unique identification code of the first terminal;
receive and store the first identification code from the second terminal.

9. The mobile terminal according to the claim 8, wherein execution of the instructions by the at least one processor causes the at least one processor to further:
set the attribute value corresponding to the superuser permission to be valid after the first identification code is prestored.

10. The mobile terminal according to claim 8, wherein the wireless connection is infrared connection.

11. A non-transitory computer readable medium storing executable instructions that, when executed by a mobile terminal, cause the mobile terminal to:
monitor an attribute value corresponding to the superuser permission at the initialization phase of a first terminal;
restart an debug bridge service when the attribute value is valid;
verify a prestored first identification code in the restarting process of the debug bridge service; wherein the first identification code is obtained according to the unique identification code of the first terminal;
reserve the superuser permission when the first identification code passes the verification.
